(19) United States
(12) Patent Application Publication
(10) Pub. No.: US 2025/0093310 A1
(43) Pub. Date: Mar. 20, 2025

(54) METHOD AND SYSTEM FOR INJECTING AN INTERNAL STANDARD INTO A PORTABLE GAS ANALYZER SYSTEM AND AN ASSOCIATED REUSABLE SAMPLE CARTRIDGE

(71) Applicant: Inficon, Inc., East Syracuse, NY (US)

(72) Inventors: Shawn M. Briglin, Cazenovia, NY (US); Katherine A. Bartholomew, Syracuse, NY (US)

(73) Assignee: Inficon, Inc., East Syracuse, NY (US)

(21) Appl. No.: 18/885,010

(22) Filed: Sep. 13, 2024

Related U.S. Application Data
(60) Provisional application No. 63/538,874, filed on Sep. 18, 2023.

(51) Int. Cl. G01N 30/72; G01N 30/14

(52) U.S. Cl. CPC G01N 30/7206; G01N 30/14

(57) ABSTRACT

A system is disclosed for analyzing a gas sample. The system includes a sample collector structured to obtain a gas sample from an environment and a sample analyzer structured to removably couple with the sample collector. The sample analyzer is configured to: (i) measure an amount of internal standard and adsorb the measured amount of internal standard onto the sample collector; (ii) desorb the gas sample and the measured amount of internal standard from the sample collector; (iii) analyze the gas sample and the measured amount of internal standard; (iv) perform a quantitative analysis of the gas sample based on the analysis of the desorbed measured amount of internal standard; and (v) determine a type of the gas sample and an amount of the gas sample.

### CROSS REFERENCE TO RELATED APPLICATION

This application is related, and claims priority to, commonly-owned Provisional Patent Application Ser. No. 63/538,874, filed Sep. 18, 2023, having the same title. The entire contents of said application is incorporated by reference as if disclosed herein in its entirety.

### TECHNOLOGICAL FIELD

The disclosure is generally related to the field of gas sample collection and analysis. More specifically, the disclosure is related to a reusable sample cartridge for use in a sample analyzing system and an improved method of injecting an internal standard into the sample analyzing system.

### BACKGROUND

Sample collectors are used in order to collect gas samples for subsequent analysis by a sample analyzer, which may include a mass spectrometer and a chromatography column. The sample is collected by the sample collector, which includes an adsorbent tube onto which the sample is collected. Although in some cases, the collection process is passive, most typically, the sampling process is facilitated using a collector pump that pulls sample air through the sample collector. The sample collector is then brought to and docked with the analyzer where the sample gas is desorbed from the sample collector for chemical analysis. A problem with an analysis of this type using gas chromatography mass spectrometry (GCMS), is that the resulting analysis suffers from low quantitative accuracy. This is because the sample analyzermay have drifted in its response since calibrations were performed. A solution to this problem is to add an internal standard to the sample cartridge—such as with a manual syringe injection—prior to docking the cartridge to the analyzer for analysis. The internal standard will typically contain compounds with physiochemical and mass-spectral similarity to the target analytes. Internal standards will produce GCMS peaks just like target analytes, but with known quantities. Because these internal standards are also introduced while forming calibration curves, this can be used to correct for drifts in analyzer sensitivity leading to very accurate quantitation. However, this approach involving vials and syringes is difficult to accomplish accurately in the field and is not well suited for a rugged in-the-field analysis performed by untrained operators.

A second approach might be to have the analyzer system introduce the internal standards inside the analyzer, near the interface to the cartridge. The internal standards are injected into the gas stream exiting the sample cartridge prior to entering the chromatography column. If the timing is accurate, and the internal standard compounds are injected at about the same time as the cartridge is desorbed, which produces GCMS peaks that can be used to improve quantitative accuracy. However, such gas analyzer systems and associated methods of sample analysis use do not result in the internal standard being desorbed from the absorbent tube along with the sample. Accordingly, these analyzer systems and associated methods of sample analysis are unable to compensate for irregularities in the desorption process or to detect faults such as if the adsorbent tube of the sample collector is bad, or the desorption heat cycle failed, or if there is a leak. Further, in systems using an automatic injection method, one or more valves are required to be actuated in order to facilitate the introduction of a volume of internal standard into the gas analyzer system. The use of valves in the sample pathway is detrimental to the sample analysis since they can add upswept volumes that degrade chromatographic analysis. These valves may also need to be operable at high temperatures for the analysis of some compounds and often contain sealing materials such as elastomers and other wetted materials that and can further lead to the degradation of compounds, such as narcotics and compounds used in chemical warfare. Specifically, these compounds can stick to valve components and degrade, which affects the measurement accuracy which can degrade identification performance and quantitative analysis. Many gas analyzer systems thus take the shortcut of only introducing calibrant compounds directly to the MS and not to MS vis the GC. This is often referred to as a MS tune gas rather than an internal standard. Although this technique can still be used to compensate for drift in the MS, the calibrant compounds do not compensate or test other parts of the analysis system, such as for example slight drifts in the temperature of the GC column during temperature ramping which cause shifts in retention times and can degrade identification accuracy. Moreover, currently used gas analyzer systems and methods of sample analysis using remote sample collection do not use an accurately measured amount of internal standard desorbed alongside the target analytes. As a result, it is difficult to control the amount of internal standard introduced into the system, which compromises the accuracy of the analysis and can even lead to false or missing identifications.

These are just some of the problems associated with current gas analyzer systems and corresponding methods of sample analysis.

### SUMMARY

Aspects of the present disclosure are directed to a system and a method for obtaining and analyzing a gas sample from an environment. In some embodiments, the method includes the step of obtaining the gas sample on a sample collector, the gas sample being obtained from a remote environment and adsorbed onto the sample collector. At another step, a measured amount of an internal standard gas is adsorbed onto the sample collector. At another step, the gas sample and the internal standard gas is desorbed from the sample collector. At a further step, the gas sample and the internal standard gas are transported into a sample analyzer. At another step, a quantitative analysis of the gas sample is performed based on an analysis of the internal standard gas. At yet another step, a type of the gas sample and an amount of gas sample are determined.

In some embodiments of the method, the quantitative analysis is performed using at least one of a chromatography column and a mass spectrometer. In some embodiments of the method, a stream of a carrier gas is passed over the sample collector to transport the gas sample and the internal standard into the sample analyzer. In some embodiments of the method, the sample collector is heated to desorb the gas sample and the internal standard gas. In some embodiments of the method, the sample collector may be reused to obtain another gas sample.

Aspects of the present disclosure are directed to a reusable sample cartridge. In some embodiments, the sample cartridge includes a cartridge housing, a collecting element positioned at least partially inside the housing, and a docking interface structured to interact with a sample analyzer. In some embodiments the collecting element is structured to adsorb a gas sample and a measured amount of an internal standard gas. In some embodiments, the gas sample and the measured amount of internal standard gas are desorbed from the collecting element at the same during an analysis process.

In some embodiments, the reusable sample cartridge further includes a filter configured to be positioned at least partially inside the housing. Some embodiments of the reusable sample cartridge further include a flow pathway structured to connect the collecting element, the filter and the docking interface. Some embodiments of the reusable sample cartridge further include a collecting element heater structured to heat the collecting element to 300° C.-400° C. In some embodiments of the reusable sample cartridge, the collecting element heater comprises a low thermal mass heating coil. In some embodiments of the reusable sample cartridge, the collecting element comprises one or more layers of a sorbent material.

Aspects of the present disclosure are also directed to a system for analyzing a gas sample. In some embodiments, the system includes a sample collector structured to obtain a gas sample from an environment, and a sample analyzer structured to removably couple with the sample collector. The sample analyzer is configured to: (i) measure an amount of internal standard and adsorb the measured amount of internal standard onto the sample collector; (ii) desorb the gas sample and the measured amount of internal standard from the sample collector; (iii) analyze the gas sample and the measured amount of internal standard; (iv) perform a quantitative analysis of the gas sample based on the analysis of the desorbed measured amount of internal standard; and (v) determine a type of the gas sample and an amount of the gas sample.

In some embodiments of the system, the analysis of the gas sample and the measured amount of internal standard comprises at least one of gas chromatography and mass spectrometry. Some embodiments of the sample collector of the system further includes a collecting element configured to adsorb the sample gas and the internal standard. In some embodiments of the system, the sample analyzer further comprises a docking interface including a sensor and the sensor is structured to determine when the sample collector is positioned at the docking interface. In some embodiments of the system, the sample analyzer further includes a reservoir of a carrier gas. In some embodiments, a stream of the carrier gas is passed from the reservoir and through the sample collector to push the desorbed sample gas and internal standard from the sample collector and into the sample analyzer. In some embodiments of the system, the carrier gas comprises at least one inert gas. In some embodiments of the system, the sample collector further comprises a housing that defines a docking end that is structured to interact with the docking interface. In some embodiments of the system, the sample collector includes a filter configured to be positioned at least partially inside the housing. Some embodiments of the system include a heater configured to heat the collecting element to desorb the sample gas and the internal standard from the collecting element. In some embodiments of the system, the amount of internal standard is measured using a measuring volume structured to contain and dispense a defined amount of internal standard into the sample collector.

### BRIEF DESCRIPTION OF DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description.

FIG. 1 schematically illustrates an embodiment of a gas analyzer in a starting state.

FIG. 2 schematically illustrates an embodiment of the gas analyzer of FIG. 1 docked with an embodiment of a reusable sample cartridge at a first state.

FIG. 3 schematically illustrates the embodiment of FIG. 2 in a second state.

FIG. 4 schematically illustrates the embodiment of FIG. 1 in a third state.

FIG. 5 schematically illustrates the steps associated with a method of gas sample analysis.

### DETAILED DESCRIPTION

The following discussion relates to various embodiments of an improved method for injecting an internal standard into a portable gas analyzer system and an associated reusable sample cartridge. It will be understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior”, “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. With regard to the drawings, their purpose is to depict salient features of the improved method for injecting an internal standard into a portable gas analyzer system and an associated reusable sample cartridge. and are not specifically provided to scale.

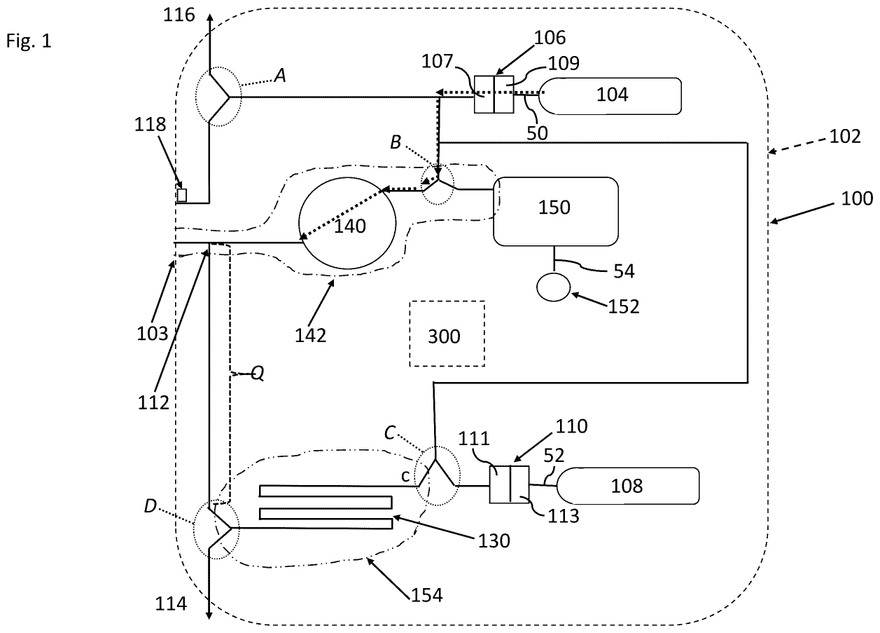

FIGS. 1-4 show an embodiment of a gas analyzer system, which includes a sample analyzer 100 and a sample collector 200. In some embodiments, such as those shown in FIGS. 1-4, the sample collector 200 comprises sample cartridge or a cartridge 201, however other embodiments of the sample collector 200 may not comprise a cartridge. In some embodiments, the sample cartridge 201 is structured to collect a gas sample from an environment and be removably coupled to the sample analyzer 100 so that the collected gas sample can be desorbed and analyzed. In some embodiments, the sample cartridge 201 is reusable. As used herein a gas sample may include any material that is in a gaseous state at conditions of standard temperature and pressure as well as chemical vapor samples, such as volatile organic compounds (VOCs) or semi-volatile organic compounds (SVOCs), which are not necessarily in a gaseous state at standard temperature and pressure conditions. As used herein, the environment may be an area that is outside of or otherwise away from the sample analyzer.

Referring to FIG. 1, a schematic depiction of an embodiment of a sample analyzer 100 is shown that includes a housing 102 surrounding at least some of the components of the sample analyzer 100 to be described and defining a docking interface 103. In an embodiment, the sample analyzer 100 includes a carrier gas reservoir 104 that is connected to a carrier gas regulator 106 via a conduit 50. In an embodiment, the carrier gas regulator 106 may include a proportional valve 109 and a pressure gauge/sensor 107. In an embodiment, the sample analyzer 100 further includes an internal standard reservoir 108 that is connected to an internal standard regulator 110 via a conduit 52. In some embodiments, the system includes more than one internal standard reservoir such that different internal standards may be used in the system. The internal standard reservoir 108 is further connected, via one or more conduits, to a flowpath manifold defining a measuring volume 130 that is structured to hold a defined amount of internal standard gas supplied by the internal standard gas reservoir 108. In some embodiments, the internal standard regulator 110 may also include a proportional valve 113 and a pressure gauge 111. The internal standard reservoir 108 is structured to contain or house an internal standard, which is a known gas composition that can be particular to the user and/or the types of gas samples that are to be measured. The internal standard can be comprised of a single compound or may be comprised of a mixture of different compounds or chemicals and is typically in a balance gas that is the same as the carrier gas, for example 100 ppb bromopentaflurobenzene in helium. The carrier gas in the carrier gas reservoir 104 is chosen to optimize the chromatographic and mass spectral analysis. In some embodiments, the carrier gas may be an inert gas, such as helium, argon or nitrogen gas. In some embodiments, the sample analyzer 100 further includes a chromatography column 140 and a mass spectrometer 150, which is connected to a vacuum pump 152 via one or more conduits 54.

The sample analyzer 100 includes a plurality of conduits or pathways that connect the various components described. A plurality of gates, valves, or switches A-D, which are connected to the conduits at various locations and are structured to direct the flow of gas through the plurality of conduits of the sample analyzer 100. The plurality of gates A-D and one or more of the components described are in communication with a controller 300. The controller 300 includes a plurality of circuits, one or more processors and memory units that are programmed to receive signals from the plurality of gates A-D, store one or more of said received signals, generate control signals based on the received signals and transmit the control signals to one or more of the plurality of gates A-D to control flow paths through the sample analyzer 100. The controller 300 is shown as being positioned within the housing 102 of the sample analyzer 100, but in other embodiments, the controller 300 may be remote from the housing 102.

As shown in the embodiment of FIG. 1, the docking interface 103 is not occupied or in contact with a sample cartridge 201. In this “starting” state, a sensor 118, such as an electrical sensor, electrical contact, or any other suitable type of sensor transmits a signal to the controller 300 indicating that no cartridge 201 is present and, in response, the controller 300 generates and transmits control signals to at least some of the plurality of gates A-D. In some embodiments, docking of the cartridge 201 at the docking interface completes an electrical pathway, which may trigger a sensor indicating that the docking interface 103 is occupied. In response to the received control signals, the plurality of gates A-D are oriented to set up an airflow pathway as shown in FIG. 1. In the starting state, the carrier gas is released from the carrier gas reservoir 104, regulated by the carrier gas regulator 106 and enabled to pass to gate B. As shown, the control signals generated and transmitted by the controller 300 switch gates A and B such that the flow of carrier gas through gate A is inhibited and the carrier gas flow through gate B is directed through the column 140 and to the docking interface 103. In this manner, the sample analyzer 100 inhibits contamination from entering the sample analyzer 100 (and specifically the chromatography column 140) when a sample cartridge 201 is not docked at the docking interface 103. In this state, the direction of the gas flow through the column 140 is generally reverse of the gas flow through the column 140 during analysis.

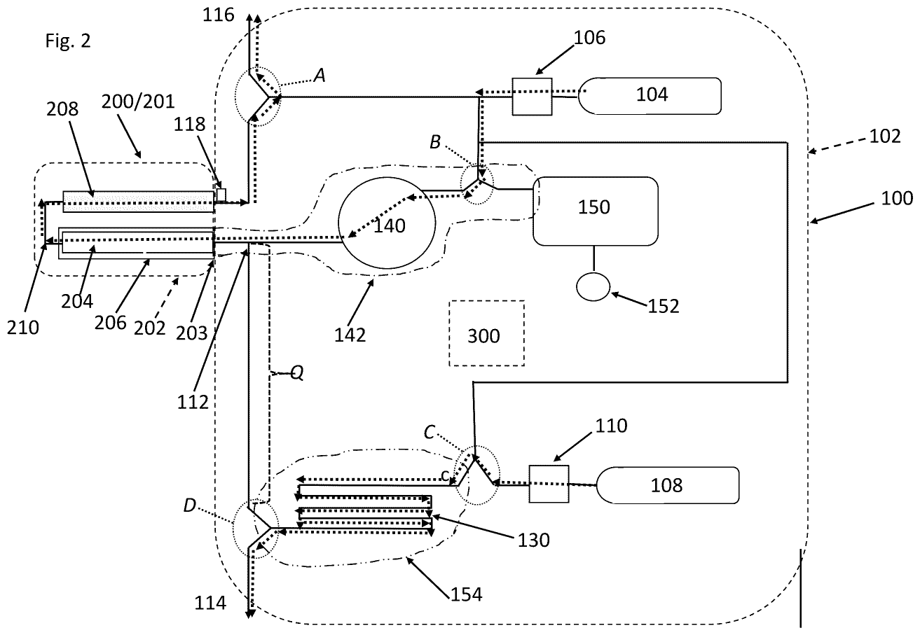

In FIG. 2, the sample cartridge 201 is docked at the docking interface 103 of the sample analyzer 100. In some embodiments, the sample cartridge 201 includes a cartridge housing 202 defining a docking end 203 that is structured to dock or otherwise interact with the docking interface 103 of the sample analyzer 100. A collecting element 204 is at least partially positioned within the housing 202 and is structured to collect a gas sample from an environment and hold the gas sample for analysis by the sample analyzer 100. In some embodiments, the collecting element 204 comprises a sorbent bed including one or more layers of different types of sorbent material, such as Tenax® and/or activated carbon sorbents, such as CarboPak™. In some embodiments, a collecting element heater 206 or heater is further included in the sample cartridge 201 and positioned relative to the collecting element 204 and structured such that it can quickly heat the collecting element 204 to desorb the gas sample for analysis by the sample analyzer 100. In some embodiments, the collecting element heater 206 is positioned in and is part of the sample analyzer 100. In some embodiments the collecting element heater 206 may comprise a low thermal mass heating coil that is structured to heat the collecting element to about 300° C.-400° C. within about 10 seconds after the collecting element heater 206 is activated. In some embodiments, the collecting element heater 206 is in electrical communication with the controller 300. In some embodiments, the heating coil comprises nichrome wire. In some embodiments, the sample cartridge 201 further includes a filter 208 that is positioned along a gas flow pathway 210 in the sample cartridge 201 that connects to the collecting element 204 and to one or more gas flow pathways of the sample analyzer 100 when the sample cartridge 201 is docked. In some embodiments, the filter 208 is at least partially positioned within the cartridge element 202.

FIG. 2 represents the initial docking of the sample cartridge 201 with the docking interface 103 of the sample analyzer 100 and will be referred to as “the first state.” In the first state, the sensor 118 transmits a signal to the controller 300 indicating that the sample cartridge 201 has just been docked. In response to said signal received from the sensor 118, the controller 300 generates and transmits control signals to at least some of the plurality of gates A-D. In response to the received control signals, the plurality of gates A-D are oriented to set up an airflow pathway as shown in FIG. 2. As shown, the position of gate B remains the same as in the starting state. As a result, the carrier gas is discharged from the carrier gas reservoir 104 and is regulated by the carrier gas regulator 106 before traveling to the docking interface 103 and into the sample cartridge 201 at the collecting element 204. As shown, the described flow pathway goes through the chromatography column 140. The carrier gas moves over the collecting element 204 and then through the filter 208 before flowing back into the sample analyzer 100. This flow path inhibits any gas sample from leaving the sample cartridge 201. Particularly, the carrier gas is pushed into the cartridge 201 as soon as cartridge docking is detected so that any trapped sample analyte is pushed back onto the collecting element 204. The carrier gas flow at this state further inhibits decomposition of the sample. Gate A is positioned to connect to a vent or exhaust 116 such that the carrier gas that has exited the sample cartridge 201 flows back through the sample analyzer 100 and out through the vent or exhaust 116. The direction of carrier gas flow is important. If the direction of the carrier gas flow were reversed, volatile chemicals held on the collecting element 204 may escape due to the asymmetrical nature of the collecting element 204.

By “asymmetrical” it is meant that the collecting element 204 is structured to collect or adsorb when the flow path through the cartridge 201 is as shown in FIG. 2 and is structured for desorption when the flow path through the cartridge 201 is in the opposite direction as that shown in FIG. 2. In other words, the one or more layers of different types of sorbent materials of the collecting element 204 are arranged in increasing adsorption strength in the sampling flow direction. Accordingly, if a particular chemical makes it through one layer or one bed, the chemical is caught on the next more adsorbent layer or bed. Moreover, some chemicals tend to be adsorbed only on the front edge of a layer or bed such that they could easily be push off the layer or bed if the gas flow through the cartridge were reversed to that shown in FIG. 2. As part of the first state, internal standard gas, such as a fluorinated hydrocarbon, is discharged from the internal standard reservoir 108 and through the internal standard regulator 110 where the discharged internal standard gas is regulated. In practice, multiple internal standards may be used at any point in the disclosed method and system. Gate C is positioned to allow the internal standard gas to be directed from the internal standard regulator 110 and into the measuring volume 130 where it travels through the measuring volume 130 to Gate D. Gate D is positioned such that the internal standard is directed out through an exhaust or vent 114 in order to purge or flush the measuring volume 130.

In the embodiments shown, the measuring volume 130 comprises a serpentine configuration having a known length and a consistent diameter such that the measuring volume is a known volume. This enables the measuring volume 130 to be reliably purged and filled. Accordingly, the first state lasts at least long enough to purge the measuring volume 130 and fill the measuring volume 130 with the internal standard. The measuring volume 130 is positioned in a temperature/pressure zone 154 of the sample analyzer 100 where the temperature and/or pressure are controlled or measured, in one embodiment, by the controller 300. Once the measuring volume 130 is filled, the first state ends and the second state begins. One way that the filling of the measuring volume 130 is controlled is to dispense internal standard gas into the measuring volume 130 at a specified rate over a specified time to get a steady state. The serpentine configuration and the small diameter (less than about 1 millimeter) of the measuring volume 130 enables the measuring volume to be completely filled with internal standard gas and subsequently purged with carrier gas such that a carefully controlled amount of internal standard is held by and dispensed from the measuring volume 130. In other embodiments, a valve may be positioned to control the dispensing of the internal standard over a set period of time instead of the described measuring volume 130. In another embodiment, gate D is closed briefly as the internal standard moves through the measuring volume 130, which results in an increase of the internal standard gas pressure to a level over 1 atm (the amount of internal standard is proportional to (pressure*volume)/temperature). In still other embodiments, the measuring volume 130 may not be a serpentine configuration as described and shown in the figures, but may instead comprise a large space or conduit having a diameter greater than about 1 millimeter and connected to the internal standard reservoir 108.

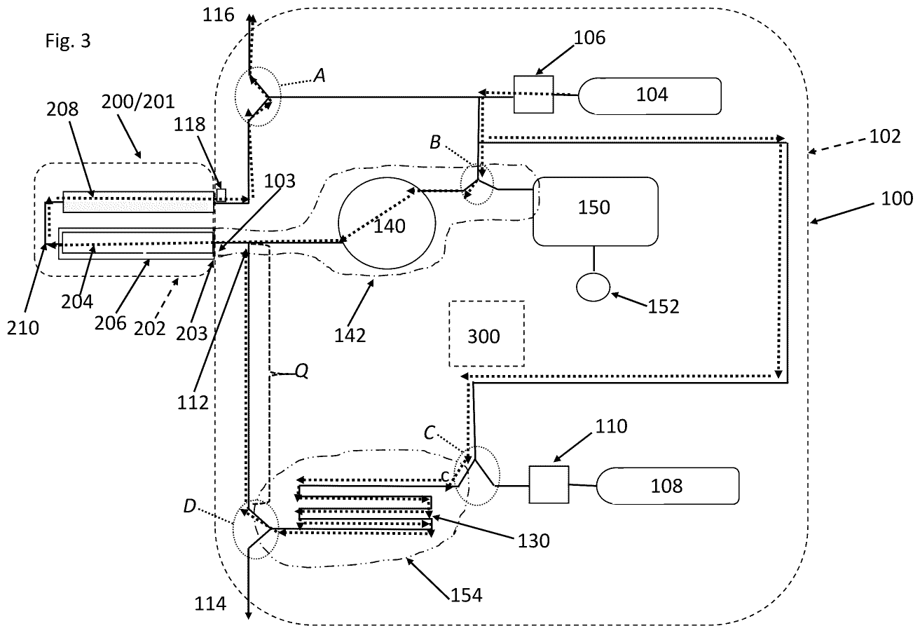

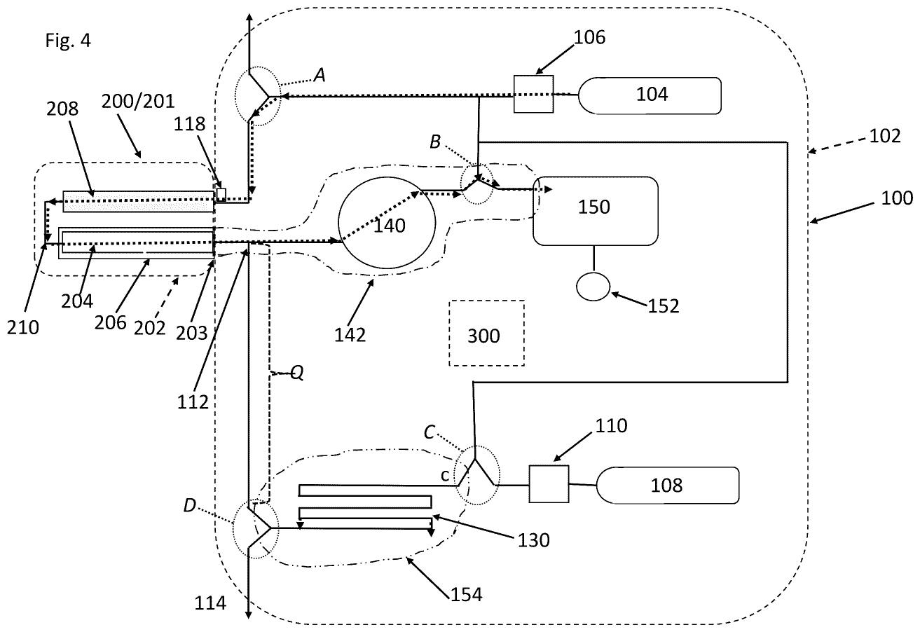

Turning to FIG. 3, during the purging of the measuring volume 130 or once the measuring volume 130 is filled, the second state is reached with the internal standard in the measuring volume 130 heated to about 70° C. (and maintained at about 1 atm. of pressure). As shown, gate C is switched to allow carrier gas to flow to the measuring volume 130, which results in the aliquot of internal standard present in the measuring volume 130 being pushed out of the measuring volume 130 through gate D and along pathway Q to the flow path interface 112. The aliquot of internal standard is then directed to the docking interface 103 by the carrier gas flowing through gate B and into the sample cartridge 201. This flow path prevents any internal standard from flowing directly into the column 140 or the mass spectrometer 150. The internal standard is then adsorbed onto the collecting element 204 and any carrier gas present is pushed through the filter 208, into the sample analyzer 100, and out through the exhaust 116 as shown in FIG. 4. In an embodiment, the internal standard may be adsorbed onto the collecting element 204 of the sample cartridge 201 prior to the sample cartridge 201 being docked with the sample analyzer 100. The second state flow path is continued for an amount of time equal to that required to evacuate the aliquot of internal standard from the measuring volume 130 and onto the collecting element 204. The structure of the measuring volume 130 enables a complete evacuation such the entire aliquot of internal standard held in the measuring volume 130 is pushed out by the carrier gas and onto the collecting element 204. After the entire aliquot of internal standard held in the volume of internal standard is pushed into the cartridge 201, the carrier gas flow is continued for an additional predetermined time to completely sweep an internal standard out of zone Q, virtual valve 112 and the docking end 203 end of sample collector 200 or sample cartridge 201. In some embodiments, the predetermined time is less than one (1) second. In some embodiments, the predetermined time is less than two (2) seconds. It is necessary to completely transport or push all internal standard compounds onto the collecting element 204 so that none remain in zone Q or unadsorbed in the cartridge 201. The predetermined time of carrier gas flow in the second state inhibits any internal standard from migrating into the column 140 before activation of the heater 206. This ensures that the sample and the internal standard are desorbed and analyzed together.

After the predetermined time has elapsed, the controller 300 generates and transmits control signals to at least some of the plurality of gates A-D. In response to the received control signals, the plurality of gates A-D are oriented to set up an airflow pathway corresponding to a third state as shown in FIG. 4. In the third state, the carrier gas stream is stopped from passing through gates B and C through a switching of gates B and C, and gate A is switched such that the carrier gas is discharged from the carrier gas reservoir 104, through the carrier gas regulator 106 and to the docking interface 103. The carrier gas, then passes into the sample cartridge 201 where it moves through the filter 208 and then through the collecting element 204. The filter 208 acts to remove any contamination that may be in the carrier gas so that it does not interfere with the analysis of the desorbed internal standard and gas sample. After moving through the collecting element 204, the carrier gas then moves back into the sample analyzer 100 where it flows to the chromatography column 140 and then to the mass spectrometer 150. In the third state, the collecting element heater 206 is activated to heat the collecting element 204 in order to desorb the internal standard and the sample gas. In some embodiments, the collecting element heater 206 is controlled by one or more control signals generated and transmitted from the controller 300 to the collecting element heater 206. The desorbed internal standard and gas sample are carried by the carrier gas flow from the sample cartridge 201 into the chromatography column 140 and the mass spectrometer 150 for analysis. The analysis of the sample gas can then be calibrated based on the analysis of the internal standard in order to determine the type and the amount of the gas sample.

Referring to the embodiments shown in FIGS. 1-4, a flow path interface or a “virtual valve” 112 is structured to inhibit flow or mixing of the sample gas during the desorption process. In some embodiments, the virtual valve comprises a “T” shape. The virtual valve 112 inhibits mixing of the sample gas during desorption at least partly due to the small diameters (less than about 1 millimeter) of the flow path interface 112 and specifically along pathway Q. A major advantage to the flow path interface 112 is that it does not comprise moving parts or sealing materials as would be found in a traditional valve. As a result flow path interface 112 of the virtual valve 112 does not cause sample degradation or contamination due to desorbed sample constituents sticking to valve components. Further because of the small dimensions which limit mixing and diffusion it does not degrade chromatographic peak shape by adding upswept volumes that would broaden chromatographic peaks.

As shown in the figures, the chromatography column 140 and the mass spectrometer 150 are part of a different temperature/pressure zone 142 within the sample analyzer 100. In an embodiment, that temperature/pressure zone 142 is controlled by the controller 300 and structured to heat to about 200°−220° C. In some embodiments, at least the chromatography column 140, which is generally kept at about 50° C. when in standby and during the period when sample gas is pushed onto the column, is heated or ramped up to about 220° C. Air passages and flow paths in various parts of the sample analyzer 100 may be heat traced in order to heat or maintain an elevated temperature of the gases passing through them. The use of the flow path interface 112 enables the valves or gates A-D to be positioned outside of the temperature/pressure zone 142, so they are not subjected to high temperatures (of about 200° C.), which could result in valve failure or desorbed sample gas sticking to valve components and degrading. However, in other embodiments, a valve may be used instead of the flow path interface 112.

A key advantage of the disclosed system and method of analyzing a gas sample is that the internal standard is adsorbed onto the same collecting element 204 as the gas sample and then desorbed from that collecting element 204 at the same time and with the exact same thermal desorption process as the gas sample. Therefore, the described system and associated method of analyzing a gas sample is able to detect infidelities in the sample cartridge 201, the desorption process, and the flow paths as well as provide a more accurate quantitative result. For example, large variations in the actual measurement value(s) of the internal standard as compared to the expected value(s) would indicate a failure in one or more states of the system. In addition, the disclosed system and method include these internal standards in calibration steps as well as during an analysis. In addition, the system and method is able to adjust for salutations where the ramping of the chromatography column 140 is not exact, for example when an analysis is run on a very cold day or a very hot day because of small thermal gradients within the analyzer.

After the sample analysis is performed, the sample cartridge 201 is removed or undocked from the sample analyzer 100. Once undocked, the sensor 118 again transmits a signal to the controller 300 indicating that no cartridge 201 is present and the controller 300 sets up the airflow pathway of the starting state as shown in FIG. 1. If, during any of the first through third states, the sample cartridge 201 is removed from the docking interface 103 of the sample analyzer 100, the sensor 118 transmits a signal to the controller 300 indicating that no cartridge 201 is present and the controller 300 sets up the airflow pathway of the starting state as shown in FIG. 1. This prevents oxygen from entering a hot chromatography column 140, which can irreversibly degrade the performance of the chromatography column 140. The sample cartridge 201 is able to be reused to acquire another sample and then docked with the sample analyzer 100 again to be analyzed.

The flow pathways described and shown in FIGS. 1-4, including the measuring volume 130 and the flow path interface 112, may be photo etched into a plate, such as a metal plate. Identically photo etched metal plates may be coupled together to form a pneumatic circuit board defining various flow paths and connecting the various components of the sample analyzer 100. The photo etched plates may be coupled together using diffusion bonding, brazing or any other known process/technique. One advantage of using photo etched plates is that the docking end 203 of the cartridge 201 and the flow path interface 112 can be positioned very close together. Using photo etched plates further allows low thermal mass heaters to be used in the zones 142, 154 as well as producing inert flow paths with narrow dimensions (less than 1 millimeter in diameter). Additionally, the photo etched plate construction further provides for a simpler and lower cost construction, for example incorporating manifold mounted valves. In an embodiment, the diameter of one or more of the flow pathways is less than about 1 millimeter. In another embodiment, the flow pathways are not constructed using photo etched plates and are assembled using a plurality of conduits fitted together or some other similar method.

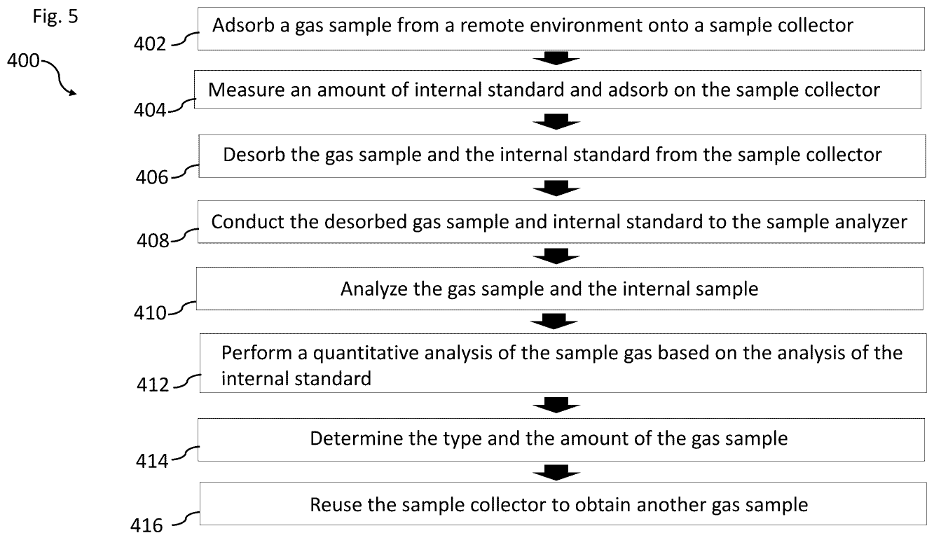

An embodiment of a method 400 of analyzing a gas sample by putting an internal standard onto a sample collector, in this case a sample cartridge 201 will be described with reference to FIG. 5. The embodiment of the method 400 begins at step 402 with collecting a gas sample from an environment by adsorbing it onto the sample cartridge 201. At step 404, an amount of internal standard is measured and adsorbed onto the sample cartridge 201 along with the gas sample. At step 406, the sample cartridge is heated so that the gas sample and the internal standard are desorbed from the sample cartridge 201 and conducted to the sample analyzer at step 408. In some embodiments, a carrier gas stream is used to conduct the desorbed sample gas and internal standard to the sample analyzer. The gas sample and the internal standard are then analyzed by the sample analyzer at step 410. A quantitative analysis of the sample gas is performed at step 412 based on the analysis of the internal standard. Next, the type and the amount of the gas sample is determined at step 414. In an embodiment, the sample cartridge 201 may then be undocked from the sample analyzer and reused at step 416 to obtain another gas sample.

This detailed description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, and is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

1. A method for obtaining and analyzing a gas sample from an environment, the method comprising:
obtaining the gas sample on a sample collector, the gas sample being obtained from a remote environment and adsorbed onto the sample collector;
connecting the sample collector to a sample analyzer;
adsorbing a measured amount of an internal standard gas onto the sample collector from the sample analyzer;
desorbing the gas sample and the internal standard gas from the sample collector at the same time;
transporting the gas sample and the internal standard gas into the sample analyzer;
performing a quantitative analysis of the gas sample based on an analysis of the internal standard gas; and
determining a type of the gas sample and an amount of gas sample.

2. The method of claim 1, further comprising performing the quantitative analysis using at least one of a chromatography column and a mass spectrometer.

3. The method of claim 1, further comprising passing a stream of a carrier gas over the sample collector to transport the gas sample and the internal standard into the sample analyzer.

4. The method of claim 1, further comprising heating the sample collector to desorb the gas sample and the internal standard gas.

5. The method of claim 1, further comprising reusing the sample collector to obtain another gas sample.

6. A reusable sample cartridge comprising:
a cartridge housing;
a collecting element positioned at least partially inside the housing; and
a docking interface structured to interact with a sample analyzer,
wherein,
the collecting element is structured to adsorb a gas sample and a measured amount of an internal standard gas, and
the gas sample and the measured amount of internal standard gas are desorbed from the collecting element at the same during an analysis process.

7. The reusable sample cartridge of claim 6, further comprising a filter configured to be positioned at least partially inside the housing.

8. The reusable sample cartridge of claim 7, further comprising a flow pathway structured to connect the collecting element, the filter and the docking interface.

9. The reusable sample cartridge of claim 6, further comprising a collecting element heater structured to heat the collecting element to 300° C.-400° C.

10. The reusable sample cartridge of claim 9, wherein the collecting element heater comprises a low thermal mass heating coil.

11. The reusable sample cartridge of claim 6, wherein the collecting element comprises one or more layers of a sorbent material.

12. A system for analyzing a gas sample, comprising:
a sample collector structured to obtain a gas sample from an environment; and
a sample analyzer structured to removably couple with the sample collector, wherein the sample analyzer is configured to,
measure an amount of internal standard and adsorb the measured amount of internal standard onto the sample collector,
desorb the gas sample and the measured amount of internal standard from the sample collector at the same time,
analyze the gas sample and the measured amount of internal standard,
perform a quantitative analysis of the gas sample based on the analysis of the desorbed measured amount of internal standard, and
determine a type of the gas sample and an amount of the gas sample.

13. The system of claim 12, where the analysis of the gas sample and the measured amount of internal standard comprises at least one of gas chromatography and mass spectrometry.

14. The system of claim 12, wherein the sample collector further comprises a collecting element configured to adsorb the sample gas and the internal standard.

15. The system of claim 12, wherein the sample analyzer further comprises a docking interface including a sensor, wherein the sensor is structured to determine when the sample collector is positioned at the docking interface.

16. The system of claim 12, wherein the sample analyzer further comprises a reservoir of a carrier gas, and wherein a stream of the carrier gas is passed from the reservoir and through the sample collector to push the desorbed sample gas and internal standard from the sample collector and into the sample analyzer.

17. The system of claim 12, wherein the amount of internal standard is measured via a measuring volume structured to contain and dispense a defined amount of internal standard into the sample collector.

18. The system of claim 15, wherein the sample collector further comprises a housing that defines a docking end that is structured to interact with the docking interface.

19. The system of claim 18, wherein the sample collector further comprising a filter configured to be positioned at least partially inside the housing.

20. The system of claim 14, further comprising a heater configured to heat the collecting element to desorb the sample gas and the internal standard from the collecting element.
